(19) United States
(12) Patent Application Publication
(10) Pub. No.: US 2004/0098266 A1
(43) Pub. Date: May 20, 2004

(54) Personal speech font

(75) Inventors: Nathan Raymond Hughes, Round Rock, TX (US); Nishant Srinath Rao, San Antonio, TX (US); Michelle Ann Uretsky, Austin, TX (US)

Correspondence Address: Robert V. Wilder, Attorney At Law, 4235 Kingsburg Drive, Round Rock, TX, 78681, US

(73) Assignee: International Business Machines Corporation, Armonk, NY

(21) Appl. No.: 10/294,992

(22) Filed: Nov. 14, 2002

(51) Int. Cl. G10L 21/00

(52) U.S. Cl. 704/277

(57) ABSTRACT

A method and implementing computer system are provided for enabling personal speech synthesis from non-verbal user input. In an exemplary embodiment, a user is prompted to input predetermined sounds in the user's own voice and those sounds are stored, along with corresponding vowel/consonant combinations, in a personal speech font file. The user is then enabled to provide text input to an electronic device and the text input is converted into verbalized speech by accessing the user's personal speech font file. The synthesized speech or greeting is stored in an audio file and transmitted to an output device. The synthesized greeting may then be played in response to a predetermined condition. Portions of the recorded greeting may be easily changed by changing the appropriate user's text file. Thus, typed text may be used to provide the basis to generate a synthesized message in a user's own voice. Passwords and other devices may be implemented to provide additional system security.

### FIELD OF THE INVENTION

The present invention relates generally to information processing systems and more particularly to a methodology and implementation for signal processing for audio output devices.

### BACKGROUND OF THE INVENTION

Most telephone systems and other communication devices which are currently available, have a capability to record a voiced greeting and have that greeting played so that a caller will hear the greeting when the user is unable to answer a phone call. The caller is then able to leave a message which is then recorded for the user to play at a more convenient time. Typically, a user will occasionally change the greeting to communicate different situations to callers. For example, a user may record a greeting that states that the user will not be available to return calls for a predetermined period of time while the user is out of the country, or on vacation, or the user may wish to have incoming calls referred to another person and number in the user's absence. Thus, the recorded message may need to be changed quite frequently in certain situations.

In the past, in order to change even a small portion of a recorded greeting, the entire greeting would have to be re-recorded. Often, errors are made in the re-recording and the greeting will have to be recorded again and again until the user is satisfied. This process is quite tedious and time consuming.

Thus, there is a need for an improved methodology and system for processing voice messages which may be generated and used in providing recorded messages for communication devices.

### SUMMARY OF THE INVENTION

A method and implementing computer system are provided for enabling personal speech synthesis from non-verbal user input. In an exemplary embodiment, a user is prompted to input predetermined sounds in the user's own voice and those sounds are stored, along with corresponding vowel/consonant combinations, in a personal speech font file. The user is then enabled to provide text input to an electronic device and the text input is converted into verbalized speech by accessing the user's personal speech font file. The synthesized speech or greeting is stored in an audio file and transmitted to an output device. The synthesized greeting may then be played in response to a predetermined condition. Portions of the recorded greeting may be easily changed by changing the appropriate user's text file. Thus, typed text may be used to provide the basis to generate a synthesized message in a user's own voice. Passwords and other devices may be implemented to provide additional system security.

### BRIEF DESCRIPTION OF THE DRAWINGS

A better understanding of the present invention can be obtained when the following detailed description of a preferred embodiment is considered in conjunction with the following drawings, in which:

FIG. 1 is a computer system which may be used in an exemplary implementation of the present invention;

FIG. 2 is a schematic block diagram illustrating several of the major components of an exemplary computer system;

FIG. 3 is a flow chart illustrating an exemplary functional flow sequence which may be used in connection with one embodiment of the present invention;

FIG. 4 is an exemplary implementation of a personal phonics translation table;

FIG. 5 is an exemplary illustration of an overall system capability;

FIG. 6 is a flow chart illustrating an exemplary functional flow sequence of a portion of a methodology which may be implemented using the present invention; and

FIG. 7 is a continuation of the flow chart illustrated in FIG. 6.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

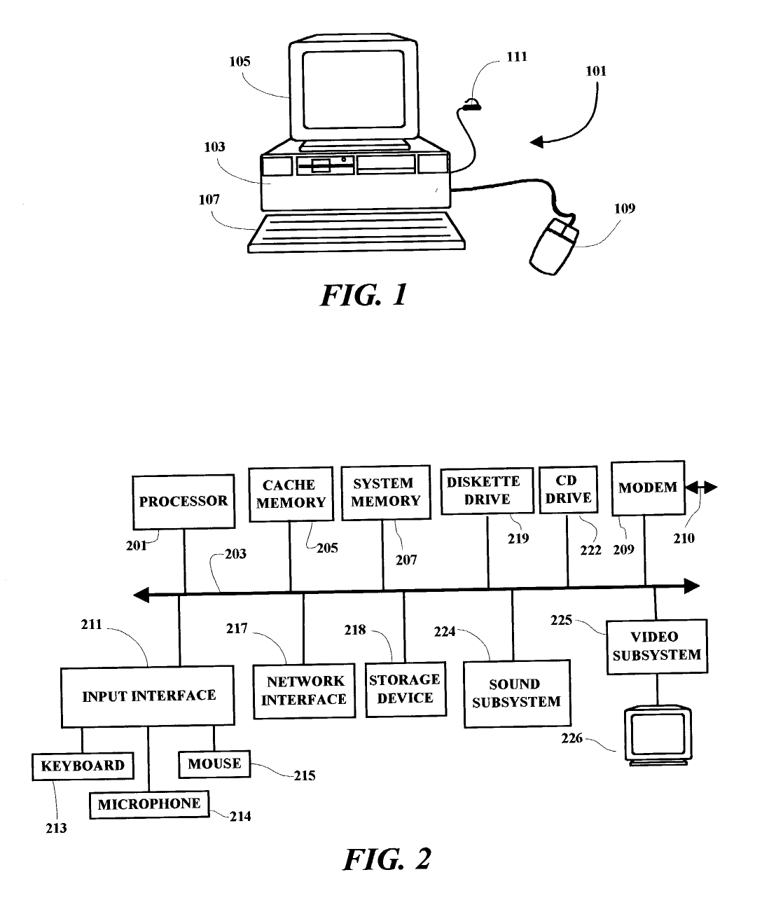

With reference to FIG. 1, the various methods discussed herein may be implemented within a computer network including a computer terminal 101, which may comprise either a workstation, personal computer (PC), laptop computer or a wireless computer system or other device capable of processing personal communications including but not limited to cellular or wireless telephone devices. In general, an implementing computer system may include any computer system and may be implemented with one or several processors in a wireless system or a hard-wired multi-bus system in a network of similar systems.

In the FIG. 1 example, the computer system includes a processor unit 103 which is typically arranged for housing a processor circuit along with other component devices and subsystems of a computer terminal 101. The computer terminal 101 also includes a monitor unit 105, a keyboard 107 and a mouse or pointing device 109, which are all interconnected with the computer terminal illustrated. Other input devices such as a stylus, used with a menu-driven touch-sensitive display may also be used instead of a mouse device. Also shown is a connector 111 which is arranged for connecting a modem within the computer terminal to a communication line such as a telephone line in the present example. The computer terminal may also be hard-wired to an email server through other network servers and/or implemented in a cellular system as noted above.

Several of the major components of the terminal 101 are illustrated in FIG. 2. A processor circuit 201 is connected to a system bus 203 which may be any host system bus. It is noted that the processing methodology disclosed herein will apply to many different bus and/or network configurations. A cache memory device 205 and a system memory unit 207 are also connected to the bus 203. A modem 209 is arranged for connection 210 to a communication line, such as a telephone line, through a connector 111 (FIG. 1). The modem 209, in the present example, selectively enables the computer terminal 101 to establish a communication link and initiate communication with network and/or email server through a network connection such as the Internet.

The system bus 203 is also connected through an input interface circuit 211 to a keyboard 213. a microphone device 214 and a mouse or pointing device 215. The bus 203 may also be coupled through a hard-wired network interface subsystem 217 which may, in turn, be coupled through a wireless or hard-wired connection to a network of servers and mail servers on the world wide web. A diskette drive unit 219 and a CD drive unit 222 are also shown as being coupled to the bus 203. A video subsystem 225, which may include a graphics subsystem, is connected to a display device 226. A storage device 218, which may comprise a hard drive unit, is also coupled to the bus 203. The diskette drive unit 219 as well as the CD drive 222 provide a means by which individual diskette or CD programs may be loaded into memory or on to the hard drive, for selective execution by the computer terminal 101. As is well known, program diskettes and CDs containing application programs represented by magnetic indicia on the diskette or optical indicia on a CD, may be read from the diskette or CD drive into memory, and the computer system is selectively operable to read such magnetic or optical indicia and create program signals. Such program signals are selectively effective to cause the computer system to present displays on the screen of a display device, or play recorded messages by the sound subsystem, and generally respond to user inputs in accordance with the functional flow of an application program.

The following description is provided with reference to a telephone system although it is understood that the invention applies equally well to any electronic messaging system including, but not limited to, wireless and/or cellular messaging systems. In accordance with the present invention, a user is enabled to input voice samples corresponding to predetermined vowel/consonant/phonic combinations spoken by the user. Those input sounds become the personal speech font of the user. That speech font is stored as a reference table, for example, and is used to generate speech messages from text input by the user. As indicated below, access to users' speech font files is controlled by password or other security devices to prevent unauthorized access.

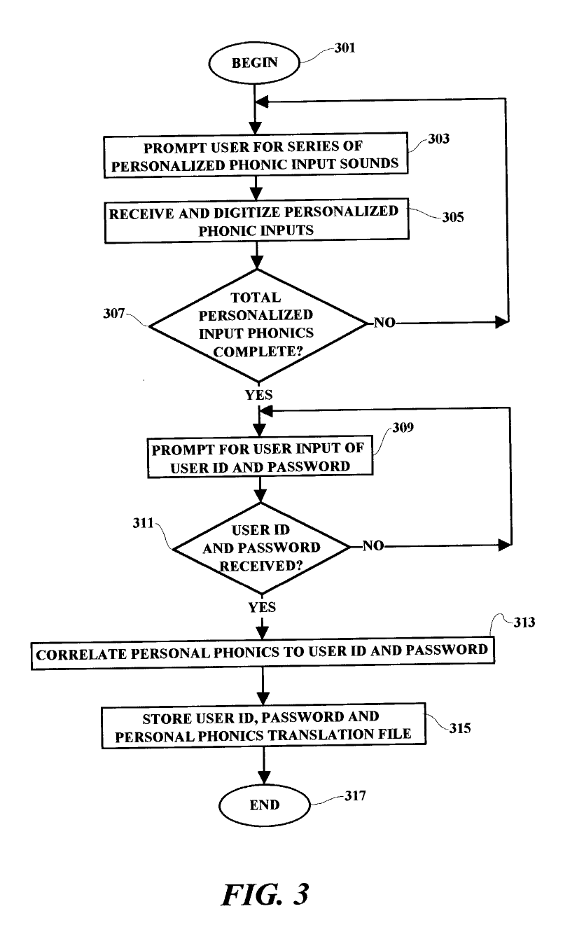

As shown in FIG. 3, the process begins 301 and an input application prompts a user to utter a series of sounds in response to a display of a particular vowel or consonant or phonic combination. When a vowel is displayed for example, the user will be prompted 303 to “sound-out” the sound of the vowel being displayed, and that sound will be picked-up by a microphone 214 which may be built into the computer. The processing system receives an audio signal from the microphone representative of the sound uttered or spoken by the user. With speech XML, a program can use the sounds from a person's speech and create new words and new combinations of words based on several sounds that can be recorded by the person. After each prompted sound is received in response to a displayed text unit (i.e. a displayed vowel or consonant or phonic), it is digitized 305 as a personalized phonic or sounded input of a particular user corresponding to the related text unit. When inputs have been received for a predetermined number of text-prompted sounds 307, the user is prompted 309 to provide a user identification (ID) and one or more passwords for example. When the user has input a user ID and password 311, the user ID and password are correlated 313 to the user's sound inputs as well as the text or text unit that was used to solicit such sounds. The correlated user ID, password, prompting text and prompted sound input are then stored in a translation table or file 315 and the personalized speech input portion of the exemplary methodology is ended 317.

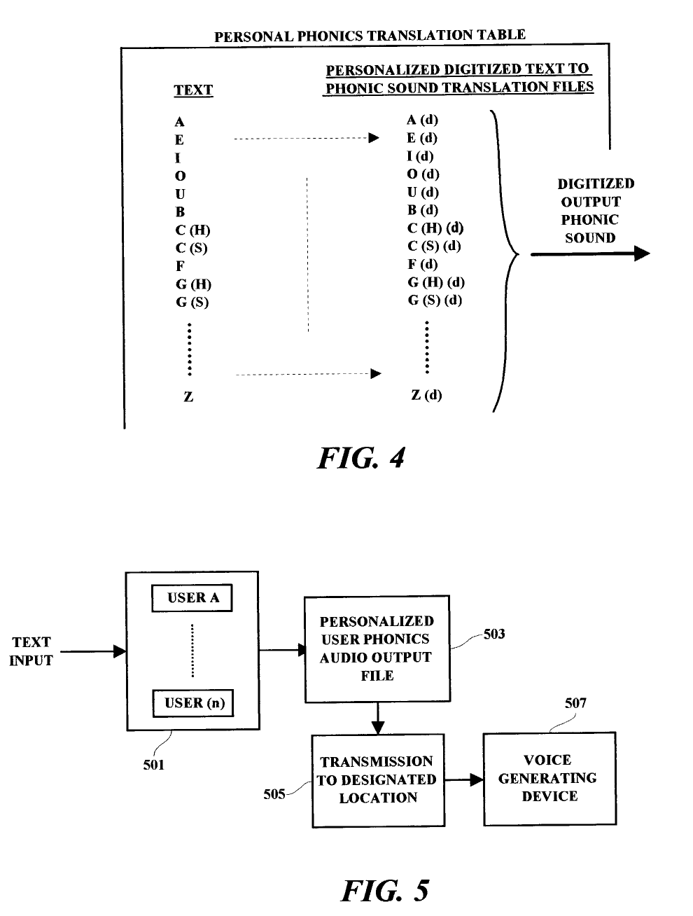

As shown in FIG. 4, when it is desired to create a voiced message in the user's own voice, the stored personal phonics translation table is accessed and used to output digitized sound signals in response to a reading or detecting of corresponding text message input from a user. For example, the detection of the vowel “a” in a text stream will be effective to cause the generation of an “a” sound in digitized form “A(d)” at an output terminal. Various sounds are similarly sequentially output in response to text which is read-in, to provide a digitized output phonic stream capable of being played by an audio player device. The translation program is also able to interpret read or detected punctuation marks and provide appropriate modifications to the output audio stream. For example, detected “commas” will cause a pause in the phonic stream and “periods” may cause a relatively longer pause.

As shown in FIG. 5, the disclosed methodology may also be implemented in a server system for multiple users A through n. Each user would have a personalized speech translation table stored 501 which may be accessed with a user ID and password to generate a personalized user phonics audio output file 503 corresponding to a text message input by the user. The personalized audio output file may then be transmitted to a designated voice generating device 507 at a designated location 505. Thus, a user, for example, is enabled to change a voiced greeting on the user's office phone by keying-in a new text message greeting into a laptop computer or other personal communication device (e.g. a cell phone) from a remote location. The typed-in text greeting is then translated through the user translation table to create a new voiced message audio file which can then be sent to and played as a greeting in automatically answering the user's office phone.

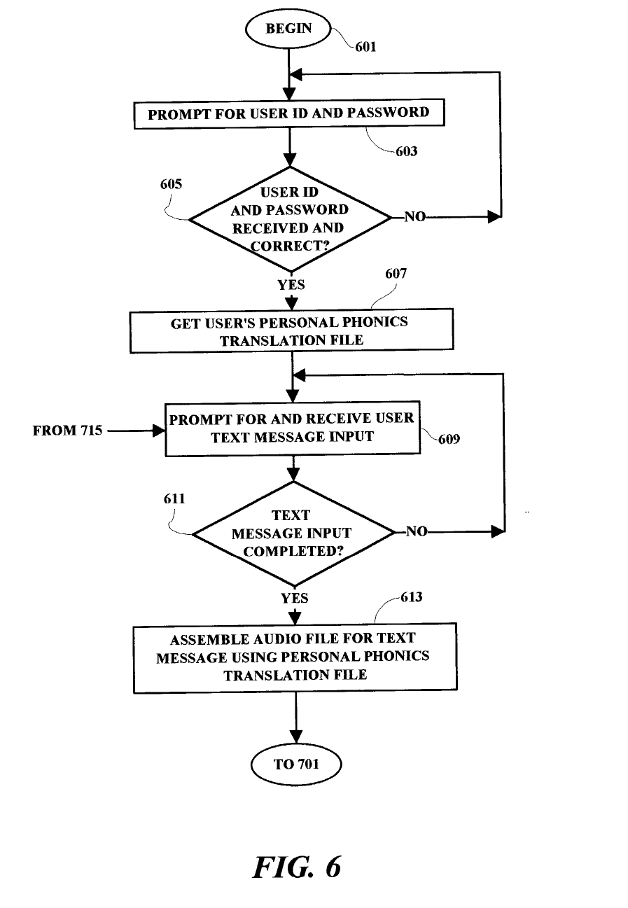

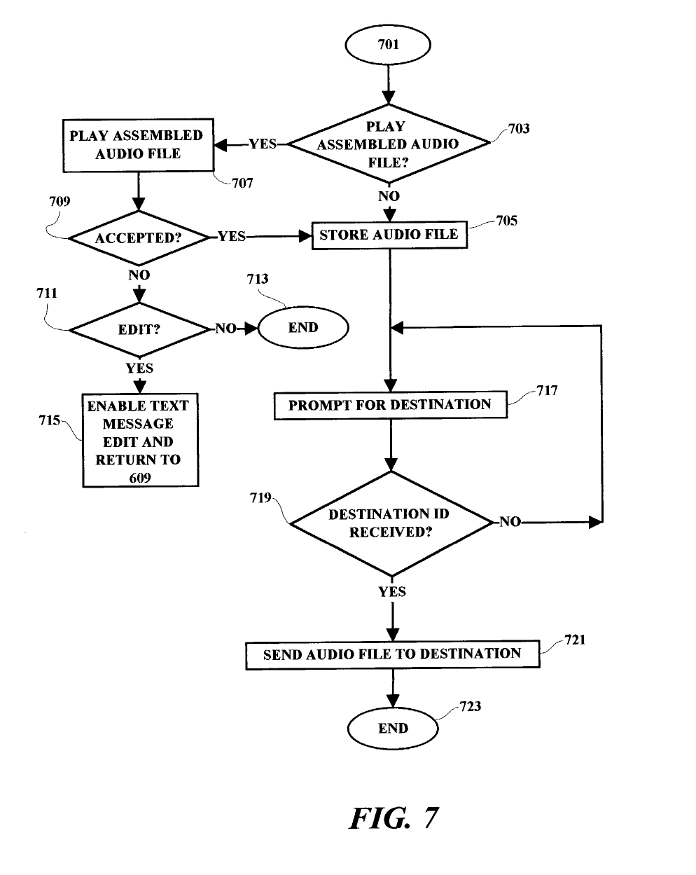

As shown in FIG. 6, the message creating processing begins 601 by prompting the user for the user ID and password 603. When a correct user ID and password have been received 605, the user's personal phonics translation file is fetched 607 or referenced 607. This step may also be done later in the process. The user is prompted to input the text message to be translated into the user's own voice 609. When the text message input is completed 611 (as may indicated for example, by the user clicking on a “Finished” icon on a display screen), an audio file is assembled referencing the user's personal phonics translation file 613 and the processing continues to block 701 in FIG. 7.

At that time, as shown in FIG. 7, a user may be prompted to indicate if the user wishes to have the synthesized voice message played back to the user for review 703. If the user selects play-back, the synthesized message is played back to the user 707 and the user may either accept or reject the synthesized message. If the user wishes to edit the message 711 after having the message played back, text message editing will be enabled 715 and the processing will return to block 609 in FIG. 6 to continue processing from that point. The user may also choose not to accept the synthesized message 709 and not to edit the message 711 in which case the process will terminate 713. When the played-back message is accepted, or if the user chose not to have the synthesized message played back, then the audio file is stored 705 and the user is prompted 717 for the identification of a destination to which the audio file is to be sent. When the destination is selected by the user, the audio file is sent to the indicated destination 721 for further processing (e.g. playing in response to a received telephone call) and the process ends 723.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing creating personal speech font files, said method comprising:
prompting a user to audibly input sounds corresponding to prompting text presented to said user;
receiving said input sounds from said user;
associating said input sounds with said prompting text presented to said user; and
creating a personal speech font file containing said prompting text and said corresponding input sounds whereby said corresponding input sounds are selectively output in response to an input of associated prompting text.

2. The method as set forth in claim 1 and further including storing said personal speech font file.

3. The method as set forth in claim 1 and further including associating said personal speech font file with said user.

4. The method as set forth in claim 3 and further including enabling only said user to access said personal speech font file.

5. The method as set forth in claim 4 and further including assigning a selected password for access to said personal speech font file, whereby access to said personal speech font file is obtained through use of said selected password.

6. The method as set forth in claim 5 and further including prompting said user to create and input said selected password.

7. The method as set forth in claim 1 wherein said prompting is accomplished by visually presenting said prompting text on a display device to said user.

8. The method as set forth in claim 1 wherein said prompting is accomplished by audibly presenting said prompting text to said user for response.

9. The method as set forth in claim 1 wherein said prompting text contains individual vowels and consonants.

10. The method as set forth in claim 9 wherein said prompting text further contains individual words.

11. The method as set forth in claim 1 wherein said input sounds are received at a local computer terminal from said user through a microphone device.

12. The method as set forth in claim 1 wherein said input sounds are received at a site remote from said user, said input sounds being transmitted from a user site to said remote site through a voice transmission system over a network.

13. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable a creation of a personal speech font file, said program signals being selectively operable to accomplish the steps of:
prompting a user to audibly input sounds corresponding to prompting text presented to said user;
receiving said input sounds from said user;
associating said input sounds with said prompting text presented to said user; and
creating a personal speech font file containing said prompting text and said corresponding input sounds whereby said corresponding input sounds are selectively output in response to an input of associated prompting text.

14. The medium as set forth in claim 13 wherein said program signals are further effective to enable storing said personal speech font file.

15. The medium as set forth in claim 13 wherein said program signals are further effective to enable associating said personal speech font file with said user.

16. The medium as set forth in claim 15 wherein said program signals are further effective to enable only said user to access said personal speech font file.

17. The medium as set forth in claim 16 wherein said program signals are further effective to enable assigning a selected password for access to said personal speech font file, whereby access to said personal speech font file is obtained through use of said selected password.

18. The medium as set forth in claim 17 wherein said program signals are further effective to enable prompting said user to create and input said selected password.

19. The medium as set forth in claim 13 wherein said prompting is accomplished by visually presenting said prompting text on a display device to said user.

20. The medium as set forth in claim 13 wherein said prompting is accomplished by audibly presenting said prompting text to said user for response.

21. The medium as set forth in claim 13 wherein said prompting text contains individual vowels and consonants.

22. The medium as set forth in claim 21 wherein said prompting text further contains individual words.

23. The medium as set forth in claim 13 wherein said input sounds are received at a local computer terminal from said user through a voice receiving device.

24. The medium as set forth in claim 13 wherein said input sounds are received at a site remote from said user, said input sounds being transmitted from a user site to said remote site through a voice transmission system over a network.

25. A computer system comprising:
a system bus;
a CPU device connected to said system bus;
a memory device connected to said system bus;
a user input device connected to said system bus, said user input device being enabled to receive voice input from said user; and
a display device connected to said system bus, said computer system being selectively operable for creating personal speech font files by prompting a user to audibly input sounds corresponding to prompting text presented to said user on said display device, and receiving said input sounds from said user, said computer system being further selectively operable for associating said input sounds with said prompting text presented to said user and creating a personal speech font file containing said prompting text and said corresponding input sounds whereby said corresponding input sounds are selectively output in response to an input of associated prompting text.

26. A method for creating a synthesized audio message in a user's own voice from text input received from said user, said method comprising:
receiving user identification information;
receiving text input from said user;
fetching a personal speech font file associated with said user;
reading said input text; and
using said personal speech font file for said user in synthesizing said user's voice in creating an output in which said input text may be audibly presented in said user's voice.

27. The method as set forth in claim 26 wherein said output is transmitted to a playing device, said playing device being enabled for receiving said output and, in response thereto, playing said input text in said user's voice.

28. The method as set forth in claim 27 wherein said playing device is remote from said user, said output being transmitted over a network to said playing device.

29. The method as set forth in claim 28 wherein said playing device is a telephone answering device, said input text comprising a message to be audibly played in response to a call received by a selected telephone unit.

30. The method as set forth in claim 29 wherein said input text is input by said user to wireless communication device.

31. The method as set forth in claim 30 wherein said wireless communication device is a wireless telephone device.

32. The method as set forth in claim 29 wherein said input text is input by said user to a personal computer device.

33. The method as set forth in claim 32 wherein said personal computer device is a laptop computer.
